(19) United States
(12) Patent Application Publication
(10) Pub. No.: US 2021/0042528 A1
(43) Pub. Date: Feb. 11, 2021

(54) SYSTEM AND METHOD FOR LOSS PREVENTION AT A SELF-CHECKOUT SCANNER LEVEL

(71) Applicants: Malay Kundy, Lexington, MA (US); Joshua Migdal, Wayland, MA (US); Vikram Srinivasan, N. Billerica, MA (US); Matthew Farrow, Canton, MA (US)

(72) Inventors: Malay Kundy, Lexington, MA (US); Joshua Migdal, Wayland, MA (US); Vikram Srinivasan, N. Billerica, MA (US); Matthew Farrow, Canton, MA (US)

(21) Appl. No.: 16/430,835

(22) Filed: Aug. 9, 2019

(51) Int. Cl. G06K 9/00; G06Q 20/20; G07G 3/00; G07G 1/00; G06Q 20/40

(52) U.S. Cl. CPC G06K 9/00711; G06K 9/00335; G06Q 20/203; G06Q 20/4016; G07G 3/003; G07G 1/0054; G06Q 20/208

(57) ABSTRACT

Detection and prevention of loss at a retail checkout are provided. At least one camera captures video streams during a transaction at a point of sale terminal. The video streams are analyzed to detect a scan activity during the transaction. Transaction data is collected from the point of sale terminal. The scan activity is compared with the transaction data in order to detect discrepancies between the detected scan activity and the scan activity recorded in the transaction data.

### BACKGROUND

Retailers lose billions of dollars annually due to theft and other loss situations that occur right at the checkout. Such incidents include intentionally not scanning items, passing items over the scanner to fake a scan, and placing items directly in the shopping bag without scanning them. These actions can be intentional. However, they can also occur unintentionally, due to carelessness, momentary lack of attention, or other oversights by the cashier or, in the case of a self checkout, the customers themselves. Other types of loss also include examples of ticket switching, where the barcode of one item, typically a much less expensive item, is recorded by the point of sale in lieu of the item's own barcode.

Systems already exist to catch such loss. They typically involve a device which records overhead CCTV camera feeds overlooking the checkout area. The video is then analyzed through computer vision algorithms and the output of such a system is compared to the sales receipt data to see when the visual detections show a discrepancy with what is actually recorded by the POS.

With cameras getting smaller and cheaper, alternatives now exist to using overhead CCTV camera feeds. Cameras are embedded in more and more devices, and one increasingly common area where cameras are found is in the scanners of the point of sale themselves. There are other places as well where they are becoming common, including in the monitors of point of sales, lights, light poles, surrounding infrastructure, etc.

Such cameras may be used to optically detect the barcode of the items for the purpose of registering items for sale. However, those cameras as well as others embedded, attached, or in close proximity the scanner may be used for purposes other than detecting the barcodes of items.

In this disclosure, we describe an invention which utilizes cameras embedded in, attached to, or in close proximity to the scanner in a point of sale setup. Such a setup may be a manned station, operated by a trained cashier. It may also be a self checkout unit, in which the customer conducts the sale.

Systems invented by the applicant and protected in previous patents, U.S. Pat. Nos. 7,516,888, 7,631,808, 8,146,811, 8,448,858, inter alia, use video analytics to track items at the checkout and ensure each item is rung up properly. These systems automatically analyze the video feeds, observing which items are available for purchase, and compare that to the transaction details to ensure all items available for purchase have a corresponding record in the transaction data.

### BRIEF DESCRIPTION OF THE DRAWINGS

FIG. 1 depicts various views from cameras situated in, on, or in close proximity to a scanner device of a retail point of sale checkout terminal, according to an embodiment.

FIG. 2 depicts various views of frames of video from a camera situated new the canner and monitoring output area of a self checkout, according to an embodiment.

FIG. 3 depicts various view of frames of video from a camera situated near the canner and monitoring the input area of a self-checkout, according to an embodiment.

FIG. 4 depicts various views of a disparity map extracted from a stereoscopic camera situated near a scanner, according to an embodiment.

FIG. 5 depicts various views of views for simulating narrow depth of field using stereoscopic depth information, according to an embodiment.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

In referring to the description, specific details are set forth in order to provide a thorough understanding of the examples disclosed. In other instances, well-known methods, procedures, components, and materials have not been described in detail as not to unnecessarily lengthen the present disclosure.

Preferred embodiments of the present invention may be described hereinbelow with reference to the accompanying drawings. In the following description, well-known functions or constructions are not described in detail because they may obscure the invention in unnecessary detail. No language in the specification should be construed as indicating any unclaimed element as essential to the practice of the embodiments. For this disclosure, the following terms and definitions shall apply:

It should be understood that if an element or part is referred herein as being “on”, “against”, “in communication with”, “connected to”, “attached to”, or “coupled to” another element or part, then it can be directly on, against, in communication with, connected, attached or coupled to the other element or part, or intervening elements or parts may be present.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

The terminology used herein is for the purpose of describing particular embodiments only and is not intended to be limiting. As used herein, the singular forms “a”, “an”, and “the”, are intended to include the plural forms as well, unless the context clearly indicates otherwise. It should be further understood that the terms “includes” and/or “including”, when used in the present specification, specify the presence of stated features, integers, steps, operations, elements, and/or components, but do not preclude the presence or addition of one or more other features, integers, steps, operations, elements, components, and/or groups thereof not explicitly stated.

The terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first set of one or more lines of code and may comprise a second “circuit” when executing a second set of one or more lines of code. As utilized herein, circuitry is “operable” to perform a function whenever the circuitry comprises the necessary hardware and code stored to a computer readable medium, such as a memory device (if any is necessary) to perform the function, regardless of whether performance of the function is disabled or not enabled (e.g., by an operator-configurable setting, factory trim, etc.).

As used herein, the words “about” and “approximately,” when used to modify or describe a value (or range of values), mean reasonably close to that value or range of values. Thus, the embodiments described herein are not limited to only the recited values and ranges of values, but rather should include reasonably workable deviations. As utilized herein, circuitry or a device is “operable” to perform a function whenever the circuitry or device comprises the necessary hardware and code (if any is necessary) to perform the function, regardless of whether performance of the function is disabled, or not enabled (e.g., by a user-configurable setting, factory trim, etc.).

As used herein, the terms “communicate” and “communicating” refer to (1) transmitting, or otherwise conveying, data from a source to a destination, and/or (2) delivering data to a communications medium, system, channel, network, device, wire, cable, fiber, circuit, and/or link to be conveyed to a destination. The term “database” as used herein means an organized body of related data, regardless of the manner in which the data or the organized body thereof is represented. For example, the organized body of related data may be in the form of one or more of a table, a map, a grid, a packet, a datagram, a frame, a file, an e-mail, a message, a document, a report, a list, or data presented in any other form.

The term “data” as used herein means any indicia, signals, marks, symbols, domains, symbol sets, representations, and any other physical form or forms representing information, whether permanent or temporary, whether visible, audible, acoustic, electric, magnetic, electromagnetic, or otherwise manifested. The term “data” is used to represent predetermined information in one physical form, encompassing any and all representations of corresponding information in a different physical form or forms.

The term “exemplary” means serving as a non-limiting example, instance, or illustration. Likewise, the terms “e.g.” and “for example” set off lists of one or more non-limiting examples, instances, or illustrations.

The term “network” as used herein includes both networks and inter-networks of all kinds, including the Internet, and is not limited to any particular network or inter-network.

The term “processor” as used herein means processing devices, apparatuses, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing.

Various operations may be described as multiple discrete operations in turn, in a manner that may be helpful in understanding embodiments; however, the order of description should not be construed to imply that these operations are order dependent.

Spatially relative terms, such as “under” “beneath”, “below”, “lower”, “above”, “upper”, “proximal”, “distal”, and the like, may be used herein for ease of description and/or illustration to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable. Such descriptions are merely used to facilitate the discussion and are not intended to restrict the application of disclosed embodiments.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

Some embodiments of the present invention may be practiced on a computer system that includes, in general, one or a plurality of processors for processing information and instructions, RAM, for storing information and instructions, ROM, for storing static information and instructions, a database such as a magnetic or optical disk and disk drive for storing information and instructions, modules as software units executing on a processor, an optional user output device such as a display screen device (e.g., a monitor) for display screening information to the computer user, and an optional user input device.

As will be appreciated by those skilled in the art, the present examples may be embodied, at least in part, a computer program product embodied in any tangible medium of expression having computer-usable program code stored therein. For example, some embodiments described below with reference to flowchart illustrations and/or block diagrams of methods, apparatus (systems) and computer program products can be implemented by computer program instructions. The computer program instructions may be stored in computer-readable media that can direct a computer or other programmable data processing apparatus to function in a particular manner, such that the instructions stored in the computer-readable media constitute an article of manufacture including instructions and processes which implement the function/act/step specified in the flowchart and/or block diagram. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In the following description, reference is made to the accompanying drawings which are illustrations of embodiments in which the disclosed invention may be practiced. It is to be understood, however, that those skilled in the art may develop other structural and functional modifications without departing from the novelty and scope of the instant disclosure.

The system disclosed herein may comprise one or more computers or computerized elements, in communication with one another, working together to carry out the different functions of the system. The invention contemplated herein may further comprise a non-transitory computer readable media configured to instruct a computer or computers to carry out the steps and functions of the system and method, as described herein. In some embodiments, the communication among the one or more computer or the one or more processors alike, may support a plurality of encryption/decryption methods and mechanisms of various types of data.

The system may comprise a computerized user interface provided by one or more computing devices in networked communication with each other. The computer or computers of the computerized user interface contemplated herein may comprise a memory, processor, and input/output system. In some embodiments, the computer may further comprise a networked connection and/or a display screen. These computerized elements may work together within a network to provide functionality to the computerized user interface. The computerized user interface may be any type of computerized interfaces known in the art capable of allowing a user to input data and receive a feedback therefrom. The computerized user interface may further provide outputs executed by the system contemplated herein.

Database and data contemplated herein may be in the format including, but are not limiting to, XML, JSON, CSV, binary, over any connection type: serial, Ethernet, etc. over any protocol: UDP, TCP, and the like.

Computer or computing device contemplated herein may include, but are not limited to, virtual systems, Cloud/remote systems, desktop computers, laptop computers, tablet computers, handheld computers, smartphones and other cellular phones, and similar internet enabled mobile devices, digital cameras, a customized computing device configured to specifically carry out the methods contemplated in this disclosure, and the like.

Network contemplated herein may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network may include multiple networks or sub-networks, each of which may include, for example, a wired or wireless data pathway. The network may include a circuit-switched voice network, a packet-switched data network, or any other network able to carry electronic communications. Examples include, but are not limited to, Picture Transfer Protocol (PTP) over Internet Protocol (IP), IP over Bluetooth, IP over WiFi, and PTP over IP networks (PTP/IP).

The system described herein may implement a server. The server may be implemented as any of a variety of computing devices, including, for example, a general purpose computing device, multiple networked servers (arranged in cluster or as a server farm), a mainframe, or so forth. The server may be installed, integrated, or operatively associated with the system. The server may store various data in its database.

The system described herein may be implemented in hardware or a suitable combination of hardware and software. In some embodiments, the system may be a hardware device including processor(s) executing machine readable program instructions for analyzing data, and interactions between the components of the system. The “hardware” may comprise a combination of discrete components, an integrated circuit, an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications or on one or more processors. The processor(s) may include, for example, microprocessors, microcomputers, microcontrollers, digital signal processors, central processing units, state machines, logic circuits, and/or any devices that manipulate signals based on operational instructions. Among other capabilities, the processor(s) may be configured to fetch and execute computer readable instructions in a memory associated with the system for performing tasks such as signal coding, data processing input/output processing, power control, and/or other functions. The system may include modules as software units executing on a processor.

The system may include, in whole or in part, a software application working alone or in conjunction with one or more hardware resources. Such software applications may be executed by the processor(s) on different hardware platforms or emulated in a virtual environment. Aspects of the system, disclosed herein, may leverage known, related art, or later developed off-the-shelf software applications. Other embodiments may comprise the system being integrated or in communication with a mobile switching center, network gateway system, Internet access node, application server, IMS core, service node, or some other communication systems, including any combination thereof. In some embodiments, the components of system may be integrated with or implemented as a wearable device including, but not limited to, a fashion accessory (e.g., a wrist band, a ring, etc.), a utility device (a hand-held baton, a pen, an umbrella, a watch, etc.), a body clothing, or any combination thereof.

The system may include a variety of known, related art, or later developed interface(s)(not shown), including software interfaces (e.g., an application programming interface, a graphical user interface, etc.); hardware interfaces (e.g., cable connectors, a keyboard, a card reader, a barcode reader, a biometric scanner, an interactive display screen, etc.); or both. The system may operate in communication with a data storage unit and a transmitter.

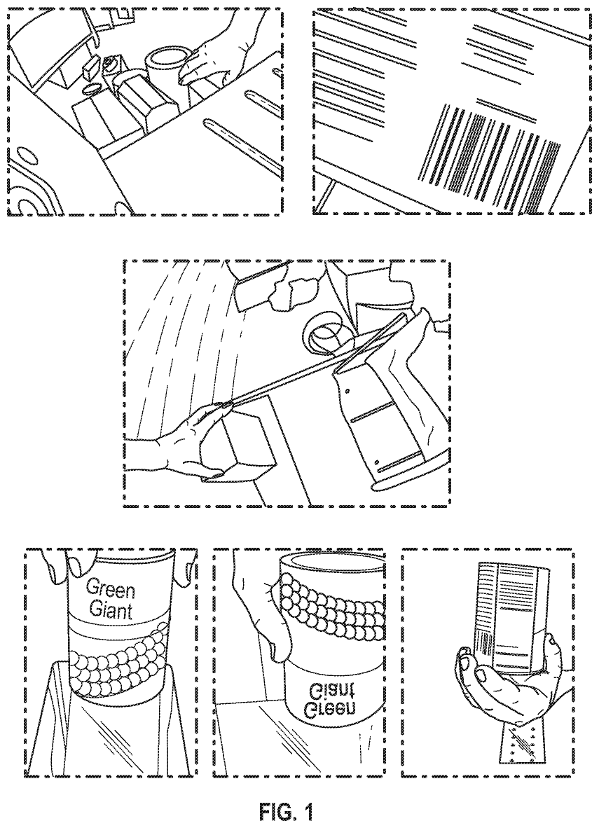

The cameras can be included within the scanner device as an integrated unit. They can also be added to an existing scanner as an add-on. Furthermore, they can be affixed to the scanner unit, or be situated nearby. See FIGS. 1-3 for examples of such camera viewpoints.

FIG. 1 illustrates various views from cameras situated in, on, or in close proximity to a scanner device of a retail point of sale checkout terminal.

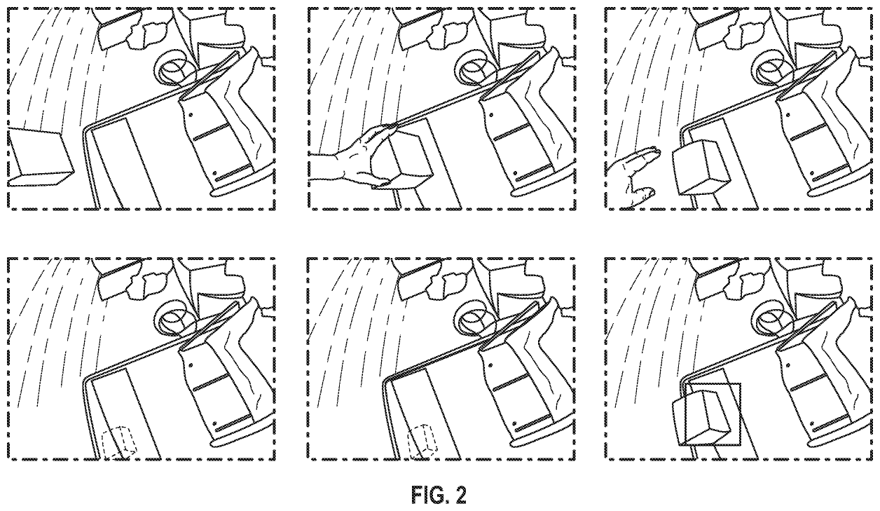

FIG. 2 illustrates item pick-up and drop-off detection. The top-row includes frames of video from a camera situated near the scanner and monitoring the output area of a self-checkout. Three frames of video are showing an item being put down in the output region of the self checkout unit. The bottom-row illustrates an object layer map of a computer vision system monitoring the output region. As the item is put down, the object layer map updates to show the presence of the new item. The bounding box and other image details of the item are now available to the computer vision system for further processing.

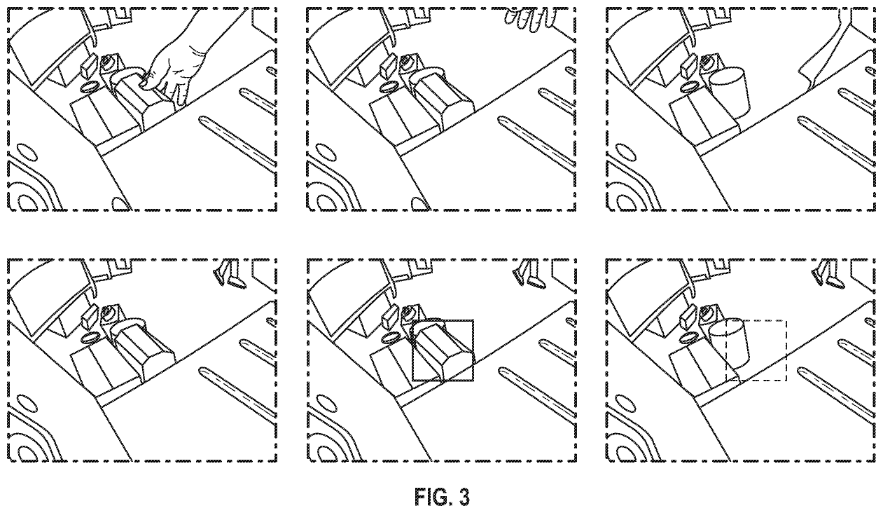

FIG. 3 illustrates item pick-up and drop-off detection. The top-row includes frames of video from a camera situated near the scanner and monitoring the input area of a self checkout. Three frames of video are showing an item being picketed up from the input region of the self checkout unit. The bottom-row shows an object layer map of a computer vision system monitoring the input region. As the item is picked up, the object layer map updates to show the absence of the item. The bounding box and other image details of the item before it was picked up are now available to the computer vision system for further processing.

### Missed Scan Detection

One method of loss prevention employed herein involves detecting when items are not scanned correctly. This could be because the operator intentionally doesn't scan an item, intending to steal it. It could also be due to inattention of the operator, who may have thought they scanned it but in, fact, it wasn't registered by the point of sale. Either case results in a loss to the retailer, and should be avoided if possible.

There system described herein can detect such occurrences, whether they were intentional or not.

Using camera shots as shown in FIGS. 1-3, an item is detected via a computer vision system as being handled by the operator. At a time in close proximity to the computer vision detection, a scan event should be recorded by the POS. By the time the item is detected as being put down in the output region, the scan certainly should have been recorded. If it has not been, then the action is flagged by the system as a missed scan.

One or more of the regions mentioned can be employed in the detection of missed scans. Each region individually—the input region, output region, or scanner region—can be used in isolation to detect the missed scan event. Furthermore, the regions in combination can be used to detect a more complex, or robust, pattern of activity indicating the action.

By way of a nonlimiting example, the input region can be used in used in isolation to detect a missed scan event in the follow way. As shown in FIG. 3, an item is detected as being picked up from the input region. A scan event from the point of sale should follow shortly. If it does not, that is indicative of a missed scan.

Similarly, the output region can be used in isolation. As shown in FIG. 2, an item is detected as being put down in the output region. If this was not preceded by a corresponding scan event from the point of sale, this is indicative of a missed scan.

Furthermore, by way of a nonlimiting example, multiple regions can be used in conjunction to provide a more robust estimate of an item handling activity. In this embodiment, an item pickup event is detected from the computer vision system monitoring the input region. Some short time later, an item drop-off event is detected from the computer vision system monitoring the output region. If an associated scan event was not detected between these two computer vision events, that is indicative of a missed scan event.

This system can be further enhanced using the item image information extracted during the pick-up and drop-off detection steps. Such imagery can be compared to ensure the same item that was picked up was dropped off.

### Ticket Switching Detection

Another form of loss detected by the invention described herein is a method of theft called ticket switching. In this modality, the barcode of the item is switched for one of a less expensive item.

There are a multitude of methods to do this, all of which are detectable by the invention described herein. One way is to tape over the legitimate barcode with a barcode of a less priced item. Another way is to affix the barcode to the item and scan the fraudulent barcode. Another way is to scan a different barcode while handling the stolen one. This different barcode could be on the person conducting the theft, or on another item they keep nearby for the purpose. Yet another way is to use the price lookup (PLU) feature to register an item for sale rather than scanning the barcode. In this way, for example, an item would be put on the scanner which also acts as a weight scale, and the PLU code for (for example) bananas would by typed in, bananas being relatively inexpensive and the PLU code easily remembered.

Such methods can be detected by refining the method of associating item pick-up/drop-off events to a particular scan event. In the non-limiting examples described previously, a temporal association was implied to match detections with scan activities registered by the point of sale. More sophisticated approaches can also be taken however. For instance, an item image database can be collected and maintained based on imagery collected during the normal operation of the point of sale from the cameras described herein or from other sources. During the step of associating a scan event with the computer vision detections, the imagery or item models associated with the particular item SKU can be queried and the pick-up and drop-off imagery can be compared to the models to see if there is a match. If the match to the appropriate item based on scanned SKU is poor, or if a match to another SKU is better, the system flags this as a potential ticket switching event.

Furthermore, such a system can self correct over time. One of the most difficult parts of maintaining an item image or item model database is updating it over time to incorporate changes to product packaging, adding new items to the database, or removing old ones.

The system described herein incorporates the results it detects to update the item database. For instance, when it consistently sees this type of product mismatch from item imagery to item model database, the system updates its item database. This leverages the fact that theft events are rare compared to the normal events seen between 100 and 1,000 times more frequently. The majority of imagery and events the computer vision system processes will be normal, such that if the system is consistently misclassifying a particular item as being ticket switched, it is far more likely this is due to product package changes rather than due to a massive increase is theft activity.

### Activity Gating

Cameras can be strategically chosen to provide a very small (or specific) depth of field. In this way, only imagery very close to where the camera is situated—i.e. the scanner and proximal regions—will be within the camera's visible area. See FIG. 1, bottom, for imagery from such cameras and lenses.

However, if normal cameras with traditional lenses are to be employed (FIG. 1, top), it is possible that activity well away from the point of sale is picked up by the cameras. The invention described herein would benefit from being able to classify activity as being proximal to the point of sale or further way.

Special purpose range sensing devices can be incorporated into the scanner unit for this purpose. Such signals can either be used to gate the operation of the computer vision system, turning it on or off depending on activity proximal to the scanner, or by incorporating the range sensing information directly into its decision making processes.

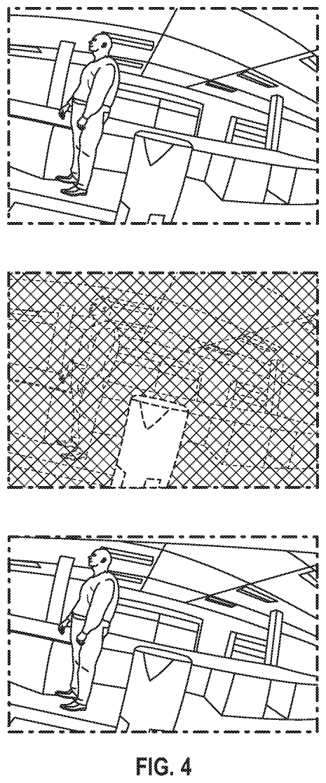

Furthermore, the cameras themselves can be used for ranging. For instance, the stereoscopic cameras can be used to create a dense depth map of the scene, enabling greater processing capabilities as well as being used as the range sensor for activity gating purposes. See FIG. 4 for details.

FIG. 4 illustrates a disparity map extracted from a stereoscopic camera situated near a scanner. The left and right depict images taken from a stereoscopic camera setup. The middle depicts the disparity map extracted from the images. Such images are useful in determining object distances from the camera, and hence to the point of sale and scanner device. They can be used as part of a computer vision system for detection, as well as for proximity analysis.

### Stereoscopic Depth of Field

As described in the previous section, stereoscopic cameras can be used to determine when activity is taking place near to the scanner, or point of sale, and to ignore activity taking place away from the point of sale.

Strategic choices of cameras and lenses can also be used to provide a narrow depth of field, enabling in-focus views of objects only close by. This, however, has the disadvantage of never being able to recover clear shots of items in the camera's field of view that are further away. Such an ability could be useful to a loss prevention or other system.

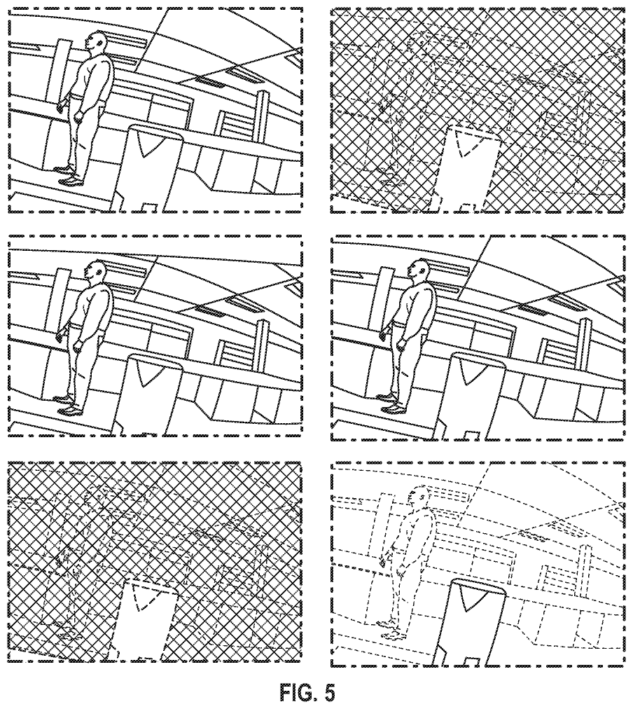

Fortunately, we can simulate the narrow depth of field provided by strategic choices of cameras and lenses using stereoscopic cameras and the depth information extracted from them without permanently sacrificing focus of far away objects. In FIG. 5, for example, one of the images from the stereoscopic camera (left) is processed with the depth information (middle) to produce the simulated narrow depth of field imagery (right). his is done by applying a blur filter whose strength is modulated by the brightness/depth of the disparity map.

Such a technique can also be used to satisfy certain privacy requirements, such as the EU's GDPR. To generalize, the disparity map can provide a method of modulating the strength of any masking algorithm, to selective, though continuously, apply the masking parameter across the image in a way that captures the areas necessary for the business purpose, whether near or far, while masking away other areas caught in the camera's field of view.

FIG. 5 illustrates simulating a narrow path of field using stereoscopic depth information. The disparity map (middle) is used in conjunction with one of the two images in the stereoscopic view (left) to create a version of the image that simulates the effect of a lens with a narrow depth of field (right). This is useful in blurring objects that are far away while keeping focus of those objects close by. By simulating the depth field, however, the clarity of faraway objects can still be recovered as necessary.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the present disclosure. Thus, it is to be understood that the invention may therefore by practiced otherwise than as specifically described above. Many other modifications, variations, applications, and alterations of the present disclosure will be ascertainable to those having ordinary skill in the art. The above-cited patents and patent publications are hereby incorporated by reference in their entirety.

What is claimed is:

1. A system for the detection and prevention of loss at a retail checkout, the system comprising:
at least one camera embedded in, situated near, or proximal to a scanner device installed at the point of sale,
a data source of transaction data,
a computer device for the processing a video, data, and other information sources, the computer device performing the steps of:
analyzing via the computer device the at least one video streams from the at least one cameras, to detect activity associated with scan activity,
collecting transaction data via the data source, and
comparing the detected activity with the transaction data in order to detect discrepancies between the detected scan activity and the scan activity recorded in the transaction data.

2. The system of claim 1, wherein at least one camera is a plurality of cameras, wherein detecting activity takes place across the plurality of cameras.

3. The system of claim 1, wherein detecting discrepancies further comprises:
extracting imagery of items as they are picked up and dropped off,
determining if the imagery of the items picked up matches the imagery of the items dropped off.

4. The system of claim 1, wherein detecting discrepancies further comprises extracting imagery of items as they are picked up and dropped off,
obtaining the associated SKU of the product from the data source,
obtaining an item model associated with the SKU,
comparing the extracted item imagery with the item model.

5. The system of claim 1, wherein activity in the video is modulated according to distance of the activity from the point of sale.

6. The system of claim 5, wherein the modulation is performed by simulating depth of focus from the original imagery and a disparity map extracted from a stereoscopic camera.

7. The system of claim 5, wherein the modulation serves to mask the video in such a way as to preserve detail in one part of the scene but to eliminate detail in others.
